(19) United States
(12) Patent Application Publication
(10) Pub. No.: US 2010/0323177 A1
(43) Pub. Date: Dec. 23, 2010

(54) Graphene oxide sheet laminate and method

(75) Inventors: Rodney S. Ruoff, Skokie, IL (US); Sasha Stankovich, Spartanburg, SC (US); Dmitriy A. Dikin, Skokie, IL (US); SonBinh T. Nguyen, Evanston, IL (US)

Correspondence Address: Edward J. Timmer, Suite 205, 121 East Front Street, Traverse City, MI, 49684, US

(73) Assignee: Northwestern University

(21) Appl. No.: 12/152,283

(22) Filed: May 13, 2008

Related U.S. Application Data
(60) Provisional application No. 60/930,101, filed on May 14, 2007.

(51) Int. Cl. B32B 9/00; B32B 5/02

(52) U.S. Cl. 428/220; 428/688; 156/62.2

(57) ABSTRACT

A macroscale sheet laminate includes individual graphene oxide sheets layered one on another in a manner to form a self-supporting paper-like laminated product. The product can be fabricated by making a suspension of individual graphene oxide sheets and assembling the graphene oxide sheets as a laminate on a fluid-permeable support by flow-directed assembly. The laminate is dried and released from the membrane filter as a self-supporting sheet laminate.

### RELATED APPLICATIONS

This application claims priority and benefits of U.S. provisional application Ser. No. 60/930,101 filed May 14, 2007, the disclosure of which is incorporated herein by reference.

### CONTRACTUAL ORIGIN OF THE INVENTION

The invention was made with government support under Grant No. NCC-1 02037 awarded by NASA. The Government has certain rights in the invention.

### FIELD OF THE INVENTION

The present invention relates to a macroscale sheet laminate comprising individual graphene oxide sheets layered one on another in a manner to form a paper-like product.

### BACKGROUND OF THE INVENTION

Free standing paper materials or foil-like materials are an integral part of our technological society. They are used as protective layers, chemical filters, components of electrical batteries or supercapacitors, adhesive layers, electronic or optoelectronic components, and for molecular storage, among others. Inorganic “paper-like” materials based on nanoscale components such as exfoliated vermiculite or mica platelets have been intensively studied and commercialized as protective coatings, high temperature binders, dielectric barriers, and gas-impermeable membranes. Carbon-based flexible graphite foils composed of stacked platelets of expanded graphite, have long been used in packing and gasketing applications due to their chemical resistivity against most media, superior sealability over a wide temperature range, and impermeability to fluids. The discovery of carbon nanotubes brought about bucky paper, which displays excellent mechanical and electrical properties that make it potentially suitable for fuel cell and structural composite applications, among others.

Graphite oxide (GO) is a layered material consisting of hydrophilic oxygenated graphene sheets (graphene oxide sheets) bearing oxygen functional groups on their basal planes and edges. GO-based thin films had been fabricated via solvent-casting methods as described by Titelman et al., “Characteristics and microstructures of aqueous colloidal dispersions of graphite oxide”, Carbon 43, 641-649 (2005).

### SUMMARY OF THE INVENTION

An embodiment of the present invention provides a macroscale laminate sheet comprising individual graphene oxide sheets layered one on another in a manner to form a paper-like laminated product.

An illustrative method embodiment of the present invention involves making a suspension of individual graphene oxide sheets and assembling the graphene oxide sheets as a sheet laminate on a fluid-permeable support by flow-directed assembly. In a particular embodiment, the suspension is subjected to continuous vacuum-assisted filtration through a membrane filter so that the graphene oxide sheets are assembled as a laminate on the membrane filter by directional flow through the membrane filter. The laminate is dried and released from the membrane filter as a self-supporting laminate.

A macroscale sheet laminate pursuant to the present invention is advantageous in significantly outperforming many of the paper-like materials described above in stiffness and strength and in exhibiting a combination of excellent macroscopic flexibility and stiffness.

Other features and advantages of the present invention will become more readily apparent from the following detailed description taken with the following drawings.

### DESCRIPTION OF THE DRAWINGS

FIGS. 1a, 1b, and 1c are respective low, middle and high resolution SEM side-view images of an approximately 10 μm thick sample of a macroscale sheet laminate according to an embodiment of the invention.

FIG. 2a is a stress-strain curve for a 5.2 μm thick laminate sample (5-1) and reloaded fragment-sample (5-1-R), the samples being described in Table SI-2-1. The deformation can be divided into three regimes: (I) straightening where loading is started, (II) “elastic” having a modulus E (31 GPa at the first load and 35 GPa at the secomd load) in a linear region, and (III) plastic nonlinear deformation up to failure.

FIG. 2b is stress-strain curve for a 5.5 μm thick laminate sample (6-3) and reloaded fragment-sample (6-3-R), the samples being described in Table SI-2-1.

FIG. 2c is a stress-strain curve for a cyclically loaded 11 μm thick laminate sample (12-3). The solid lines indicate the loading and the dashed lines the release part of the cycle. The B and R lines are fittings of the linear stress-strain dependence with a modulus of elasticity of 27 and 32 GPa, respectively.

FIG. 2d shows the derivatives of the stress-strain curves for four different laminate samples revealing the “wash-board” pattern in the tensile loading behavior.

FIG. 2e is a stress-strain curve for a 5.5 μm thick laminate sample (6-4) and a reloaded fragment (6-4-R) showing slip-stick behavior, the samples being described in Table SI-2-1.

FIGS. 2f through 2h are stress-strain cyclic measurements for an 11 μm thick laminate sample (12-4) at 40° C., 90° C., and 120° C., respectively. The R curve in the FIG. 2h indicates the final sample pulling step prior to fracture.

FIG. 2i shows the linear thermal contraction of the same 11 μm thick laminate sample recorded between tensile tests (coefficient for linear negative thermal expansion approximately 50×10⁻⁶ l/K.

FIG. 3 is a schematic view of the continuous vacuum filtration method embodiment of the invention wherein the colloidal suspension of graphene oxide sheets in water is placed in a filtering chamber having a membrane filter at the bottom communicated to a vacuum conduit and filtered to leave a wet graphene oxide paper product on the membrane filter.

### DESCRIPTION OF THE INVENTION

An embodiment of the present invention envisions a macroscale sheet laminate comprising individual graphene oxide sheets layered one on another in a manner to form a paper-like laminated product, which is self-supporting. The paper-like product can have a thickness in the range of 1 to 50 μm for purposes of illustration and not limitation. By self-supporting is meant that the dried paper-like product can support itself as a membrane in use. A macroscale paper-like sheet laminate pursuant to the present invention is advantageous in significantly outperforming many of the paper-like materials described above (e.g. vermiculite or mica platelet paper-like products, graphite foil, bucky paper) in stiffness and strength and in exhibiting a combination of excellent macroscopic flexibility and stiffness as a result of interlocking-tiling arrangement of the nanoscale graphene oxide sheets, although do not wish or intend to be bound by any theory in this regard.

The macroscale sheet laminate can be fabricated in an illustrative method embodiment of the present invention starting with a suspension of individual graphene oxide sheets followed by assembling the graphene oxide sheets of the suspension as a laminate on a fluid-permeable support by flow-directed assembly.

A particular illustrative method of fabricating a sheet laminate involves making an aqueous suspension of individual graphene oxide sheets by exfoliating graphite oxide in water using an ultrasonic treatment to produce a stable suspension of the individual graphene oxide sheets with a mean lateral dimension of approximately 1 μm and sheet thickness of approximately 1 nm. The suspension is subjected to continuous vacuum-assisted filtration through a membrane filter so that the graphene oxide sheets are assembled as a laminate on the membrane filter by directional flow of the fluid (water) of the suspension through the membrane filter. The laminate is then dried (e.g. air dried) and mechanically released (e.g. peeled) from the membrane filter as a thin, self-supporting laminate or film comprising individual graphene oxide sheets layered one on another in a manner to form a self-supporting paper-like laminated product. Further details of this fabricating method are set forth in the EXAMPLE below.

The following EXAMPLE is offered to further illustrate the present invention but not limit the present invention.

### Example

Graphite oxide (GO) was prepared using the well-known Hummers method described by Hummers, W. S.; Offeman, R. E. in J. Am. Chem. Soc. 1958, 80, 1339-1339, the disclosure of which is incorporated herein by reference. This method typically involves preparing bulk graphite oxide using SP-1 bulk graphite (30 μm, Bay Carbon, Bay City, Mich.). In particular, the SP-1 graphite is subjected to an oxidative treatment with potassium permanganate in concentrated sulfuric acid. For example, two (2) grams graphite were placed into a round bottom flask. Concentrated sulfuric acid (46 mL) was added and the mixture cooled in an ice bath. Potassium permanganate was added to the ice cooled mixture in small portions over 30 minutes. Following this addition, the reaction mixture was stirred at 35 degrees C. for 2 hours. After the two hour period, water (92 mL) was added to the reaction mixture and stirring continued for 15 minutes. Finally, the reaction mixture was poured into 270 mL of water and excess of potassium permanganate was neutralized by adding sufficient amount of water solution (30%) of hydrogen peroixde. Graphite oxide was recovered by filtration and washed with an HCl solution (10:1 water: concentrated HCl) until sulfates are no longer detected by a barium chloride test. The graphite oxide then was dried under vacuum (30 mTorr) for 24 hours.

Preparation of laminate sheets was follows: Dried GO was exfoliated in de-ionized water (in 20 mL batches) with ultrasonic treatment (about 30 min using a Fisher Scientific FS60 ultrasonic bath cleaner, 150 W) to form a colloidal suspension (3 mg/mL) of graphene oxide sheets.

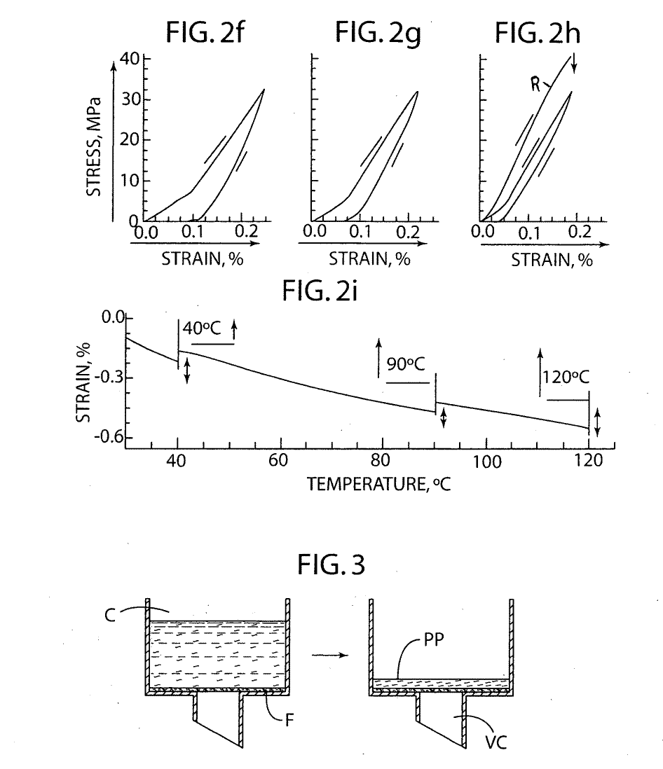

Graphene oxide paper was prepared from the suspension by continuous vacuum or suction filtration of the resulting colloid through an Anodisc® membrane filter (47 mm in diameter, 0.2-μm pore size, Whatman, Middlesex, UK) as illustrated in FIG. 3. FIG. 3 is a schematic view of the continuous vacuum filtration wherein the colloidal suspension of graphene oxide sheets in water is placed in a filtering chamber C having the membrane filter F at the bottom communicated to a vacuum conduit VC, and filtered to leave a wet graphene oxide paper product PP on the membrane filter after a time of 12 to 48 hours depending on the amount of colloidal dispersion of graphite oxide used for achieving the desired film thickness. The vacuum conduit was communicated to “house” vacuum of about 10 mm Hg and vacuum filtration was stopped when there was no visible sign of water on top of the collected, still-wet paper product. Thereafter, the wet paper product PP was suction-dried for one day followed by air drying under ambient conditions for one-two days and then peeled manually from the membrane filter to yield a paper-like product free of wrinkling, rolling, or warping. The thickness of the graphene oxide paper samples was controlled by adjusting the volume of the colloidal suspension placed in the chamber. Samples of graphene oxide paper were cut by a razor blade into rectangular strips of approximately 5×30 mm for testing.

Light microscopy (LM: Axioscop (Zeiss, Germany) and scanning electron microscopy (SEM: Nova NanoSEM (FEI Co, Hillsboro, OR)) were used to examine the paper samples. The paper material density was measured using the Archimedes method in water (33360 kit with the PB303-S DeltaRange Mettler Toledo balance, Mettler-Toledo, Switzerland).

X-ray diffraction experiments were performed at room temperature using the specular reflection mode (i.e., incident angle=exit angle). Measurements were carried out in-house with a Geigerflex (Rigaku Co., Japan) diffractometer (Cu Ka radiation, X-ray wavelength λ=1.5406 Å, operating at 40 keV, cathode current of 20 mA) under normal laboratory conditions; and at beamline X23B of the National Synchrotron Light Source (Brookhaven National Lab, NY) with a four-circle diffractometer operating at 10 keV (λ=1.2398 Å, the beam size 0.4×1.0 mm². During the ‘beamline’ measurements, the samples were kept under a slight overpressure of helium to reduce the background scattering from the ambient gas and radiation damage. The inherent and instrumental broadenings of the diffraction peak were higher for the in-house measurements. The thermal stability of graphene oxide paper was characterized by then mogravimetric analysis (TGA-SDT 2960, TA Instruments, New Castle, Del.). All measurements were conducted under dynamic nitrogen flow (industrial grade, flow rate 100 mL/min) over a temperature range of 35-800° C. with a slow ramp rate of 1° C./min to prevent sample loss.

Static mechanical uniaxial in-plane tensile tests were conducted with a dynamic mechanical analyzer (2980 DMA, TA Instruments, New Castle, Del.). The paper samples were gripped using film tension clamps with a clamp compliance of approximately 0.2 μm/N. All tensile tests were conducted in controlled force mode with a preload of 0.01 N and a force ramp rate of 0.02 N/min. The sample width was measured using standard calipers (Mitutoyo Co., Japan). The length between the clamps was measured by the DMA instrument, and the sample thickness was obtained from SEM imaging of the fracture edge.

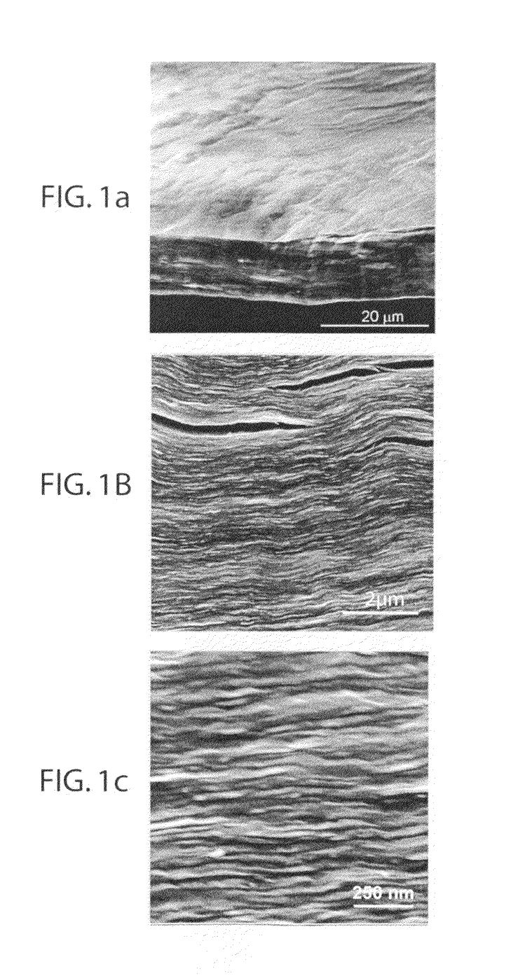

Vacuum filtration of colloidal dispersions of graphene oxide sheets through the Anodisc® membrane filter yielded, after drying, free-standing graphene oxide paper with thicknesses ranging from 1 to 30 μm. This sheet laminate is uniform and dark brown under transmitted white light and almost black in reflection when thicker than 5 μm. The fracture edges of a graphene oxide paper sample when imaged via scanning electron microscopy (SEM) revealed well-packed layers in the center of the stacks, sandwiched between less densely packed ‘wavy’ skin layers about 100-200 nm thick (FIGS. 1a, b, and c). The layering in our graphene oxide paper was evident from its X-ray diffraction (XRD) pattern where the peak in the X-ray spectrum of a typical graphene oxide paper specimen corresponds to the layer-to-layer distance (d-spacing) of approximately 0.83 nm. Based on previous studies on the dependence of d-spacing in GO on the water content, the measured distance can be attributed to approximately one-molecule-thick layer of water that presumably is hydrogen-bonded between the graphene oxide sheets, although applicants do not intend or wish to be bound by any theory in this regard. The mean dimension of an ordered stack of graphene oxide sheets in the paper sample (laminate) that are oriented perpendicular to the diffracting plane was calculated from the width of the XRD peak using the Scherrer equation (see Bartram, S. F. in Handbook of X-rays. [(ed. Kaelble, E. F.) p. 17.1-17. (McGrawHill, New York, 1967)] and was found to be 5.2±0.2 min. This size corresponds to about 6 to 7 stacked graphene oxide sheets. A summary of the paper samples prepared as described is shown in Table S1-2-1 where the thickness, width, and length of the paper samples is set forth.

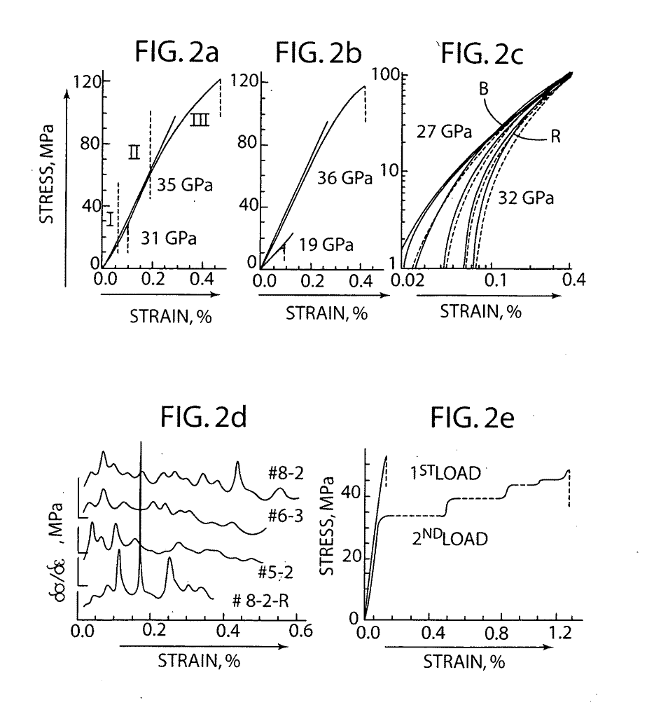

In a typical stress-strain curve three regimes of deformation can be observed for samples of graphene oxide paper: straightening, almost linear (“elastic”), and plastic (FIG. 2a). This behavior is similar to that of most paper- or foil-like materials; however, the graphene oxide paper samples were very stiff. Although there are different levels of wrinkling and “waviness” in the graphene oxide paper at different length scales, the initial straightening during the tensile loading is quite small. The rupture of graphene oxide paper samples loaded beyond the “elastic” regime is not accompanied by any pullout of its lamellae, and produces almost straight and flat fracture surfaces (FIGS. 1a, 1b, and 1c). This suggests good material homogeneity and strong interlayer binding. The ultimate tensile strain for graphene oxide paper (0.6% was the highest recorded number for samples that did not exhibit slip-stick behavior (vide infra)) is comparable to that of flexible graphite (0.5% along the rolling direction), and much lower than that of vermiculite (2.5%) and bucky paper (3-5.6%). However, the work of extension to fracture for graphene oxide paper is as high as 350 kJ/mm³ (approximate 190 J/kg, at the sample material density of approximately 1.8 g/cm³). In contrast, the corresponding values for flexible graphite foils are typically more than 10 times lower, and values for “pristine” bucky paper are of similar magnitude.

The deformation of the graphene oxide paper samples can be divided into three regimes: (I) straightening where loading is started, (II) “elastic” having a Young's modulus E, and (III) nonlinear plastic regime up to failure (see FIG. 2a). Tensile test measurements of the graphene oxide paper samples revealed exceptionally high values of tensile modulus and fracture strength (FIGS. 2a, 2b, etc. and Table S1-2-1). The average modulus of graphene oxide paper was determined to be 32 GPa (average from 31 tested samples) with the highest being 42 plus or minus 2 GPa. These values are much higher than those reported for bucky paper, flexible graphite foil, and paper-like materials based on vermiculite. The tensile strength of the graphene oxide paper samples is also considerably higher than those obtained for flexible graphite and bucky paper, and just slightly lower than the highest value reported for vermiculite-based paper materials.

Cyclic loading experiments revealed that permanent deformations were introduced in the samples even when they were loaded within the limits of the “elastic” regime (FIG. 2c). Both the load and unload portions of each subsequent cycle displayed an increase in modulus of elasticity with a total increase of about 20% after five cycles. Such self-reinforcing behavior is well-known for aligned polymer chains and other fibrous materials, where tensile loading can lead to a macromolecular/fibril alignment along the load direction and a mechanically stiffer sample. Similarly, stretching graphene oxide paper should lead to a better alignment of the 2-D lamellae and thus also the individual graphene oxide sheets, increase their contact and interactions, and result in a stiffer material. This behavior of graphene oxide paper samples is in stark contrast to that of flexible graphite foil where the elasticity modulus decreases upon stress cycling.

Interestingly, the stress-strain curves for a number of graphene oxide paper samples displayed “wash-board” patterns and sometimes even exhibited sharp upturns, manifested as a sequence of the peaks in the derivative of the stress-strain curve (FIG. 2d). Similar behavior of local reinforcing has been observed during basal plane shear in single-crystal graphite and in the material produced by layer-by-layer assembly of montmorillonite clay platelets and polyelectrolytes. However, if the paper sample was loaded into the plastic regime (FIG. 2b) and failed, then the stiffness of the reloaded segments at low strain was similar to that of the original sample just prior to its failure. These results indicate that the loss of material stiffness is not a local effect, but rather a homogeneous softening of the paper upon loading in this manner. In exceptional situations, the stress-strain response had several consecutive steps each with a large change in elongation (FIG. 2e), suggesting a slide-and-lock mechanism where the individual “nanoplates” that made up the macroscopic sample slide into place and “click” upon being progressively stressed.

Given that water molecules are present between graphene oxide sheets (vide supra) one would expect the mechanical properties of graphene oxide paper samples to strongly depend on its water content. Indeed, as the moisture content of graphene oxide paper decreases with increasing temperature, the modulus increased (from 17 to 25 GPa for the same sample shown in FIGS. 2f-2h). As expected, the loss of water is also accompanied by slow contraction of the graphene oxide paper (FIG. 2i). Simultaneously, the magnitude of permanent deformation decreases for each loading cycle conducted at 40, 90, and 120° C., respectively (FIGS. 2g-2h). These behaviors are similar to what occurs in cellulose-based paper where a wet sheet has lower strength and stiffness than a dry one.

The following table displays the complete list of the graphene oxide samples which were successfully tested via static mechanical testing in a uniaxial in-plane tensile load-to-fracture configuration. The first digit in the sample number indicates the graphene oxide membrane or laminate from which the strip was cut. Thus, samples 6-1 thru 6-5 were five strips derived from the same piece of graphene oxide paper and have similar thicknesses. R in the sample number indicates that the broken fragment of the initial sample was reloaded for the second tensile test. In particular for sample number 10-1, it was possible to reload the fragments twice.

In the Table below, t, w, L are the thickness, width, and length, of the samples, respectively. E is Young's modulus, determined by fitting the stress-strain plot in the “elastic” regime with a straight line. σ is engineering stress at fracture, referred to above as the stress and computed using the sample width and thickness of the fracture surface. ∈ is engineering strain at fracture, referred to above as the strain and computed from the instantaneous length of the sample between the clamps. W is the work of extension to fracture, the amount of energy absorbed to fracture, calculated by taking the integral beneath the stress-strain curve. The values shown above in the table are for those samples that went through the “elastic” regime (usually with the strain value above 0.3%).

Superscript 1 is a sample that showed slip-stick behavior. Superscript 2 represents tensile tests that were carried out in the temperature range between 20 and 150° C. Superscript 3 represents tensile tests were carried out at temperatures of 40, 90, and 120° C.

TABLE SI-2-1
Complete results of the tensile test.

| | | W | L | | | | |
|---|---|---|---|---|---|---|---|
| Sample | t | ±0.05 | ±0.001 | E | σ | E | |
| # | (μm) | (mm) | (mm) | (GPa) | (MPa) | (%) | W (kJ/m³) |
| 1-1 | 22 ± 1 | 5.65 | 19.033 | 22 ± 3 | 39 | 0.22 | |
| 2-1-R | 25 ± 1 | 5.2 | 9.137 | 19 ± 3 | 15 | 0.1 | |
| 2-2 | 25 ± 1 | 5.2 | 12.210 | 26 ± 2 | 32 | 0.26 | |
| 2-2-R | 25 ± 1 | 5.2 | 8.990 | 25 ± 2 | 67 | 0.8 | 348 |
| 2-3 | 25 ± 1 | 4.64 | 14.071 | 29 ± 3 | 32 | 0.1 | |
| 3-1 | 23 ± 1 | 4.6 | 23.346 | 15 ± 2 | 28 | 0.22 | |
| 3-1 R | 23 ± 1 | 4.6 | 12.593 | 18 ± 2 | 64 | 0.45 | 155 |
| 4-1 | 4.9 ± 0.2 | 5.90 | 18.115 | 37 ± 3 | 105 | 0.53 | 352 |
| 4-2 | 4.9 ± 0.2 | 4.40 | 17.618 | 34 ± 2 | 70.6 | 0.38 | 168 |
| 5-1 | 5.2 ± 0.2 | 5.05 | 19.291 | 31 ± 4 | 28.9 | 0.1 | |
| 5-1-R | 5.2 ± 0.2 | 5.05 | 15.951 | 35 ± 2 | 121 | 0.47 | 325 |
| 5-2 | 5.2 ± 0.2 | 5.03 | 18.714 | 39 ± 2 | 112 | 0.37 | 224 |
| 5-2-R | 5.2 ± 0.2 | 5.03 | 27.661 | 34 ± 4 | 85 | 0.29 | |
| 6-3 | 5.5 ± 0.2 | 5.50 | 28.387 | 36 ± 2 | 118 | 0.42 | 286 |
| 6-3-R | 5.5 ± 0.2 | 5.50 | 16.695 | 19 ± 3 | 15.8 | 0.15 | |
| 6-4 | 5.5 ± 0.2 | 5.45 | 24.608 | 41 ± 2 | 52.8 | 0.13 | |
| 6-4 R¹ | 5.5 ± 0.2 | 5.45 | 14.175 | 42 ± 2 | 32 . . . 48 | 0.1 . . . 1.28 | |
| 6-5 | 5 ± 0.2 | 5.9 | 25.435 | 36 ± 2 | 91 | 0.34 | 173 |
| 8-2 | 4.8 ± 0.2 | 5.90 | 21.155 | 37 ± 3 | 133 | 0.46 | 338 |
| 8-2 R | 4.8 ± 0.2 | 5.90 | 14.216 | 33 . . . 80 | 68 | 0.23 | |
| 10-1 | 2.5 ± 0.2 | 4.1 | 23.533 | 30 ± 3 | 62.9 | 0.22 | |
| 10-1-R1 | 2.5 ± 0.2 | 4.1 | 19.152 | 31 ± 2 | 83 | 0.32 | 129 |
| 10-1-R2 | 2.5 ± 0.2 | 4.1 | 9.742 | 34 ± 2 | 82 | 0.29 | |
| 10-3 | 2.5 ± 0.2 | 4.5 | 26.592 | 30 ± 3 | 55 | 0.21 | |
| 10-3-R | 2.5 ± 0.2 | 4.5 | 14.765 | 30 ± 1 | 112 | 0.4 | 226 |
| 12-1 | 11 ± 0.5 | 6.0 | 17.542 | 28 ± 2 | 109 | 0.48 | 270 |
| 12-1 R | 11 ± 0.5 | 6.0 | 13.103 | 29 ± 3 | 42 | 0.16 | |
| 12-2 | 11 ± 0.5 | 5.8 | 25.093 | 28 ± 2 | 92 | 0.46 | 230 |
| 12-2 R | 11 ± 0.5 | 5.8 | 11.645 | 29 ± 2 | 104 | 0.51 | 312 |
| 12-3² | 11 ± 0.5 | 5.85 | 22.600 | 27-32 | 97 | 0.4 | |
| 12-4³ | 11 ± 0.5 | 5.6 | 20.831 | 17-25 | 43 | 0.2 | |

In addition to tensile tests, the bending performance of graphene oxide paper sample was evaluated. A 25-μm thick graphene oxide paper sample could be bent to a radius of curvature of about 2 mm without delamination of the surface layers, as observed with a light microscope. A 1-μm thick graphene oxide paper sample buckled during bending when the thickness (t) to radius of curvature (R) ratio was increased from 1/75 to 1/20. According to the solution for pure uniform bending of a bar comprised of an isotropically homogeneous material, the positive (negative) normal strain, ∈ₓ, at the outer (inner) bar surface is ∈ₓ=0.5 t/R. Therefore, buckling of graphene oxide paper sample took place somewhere between strains of 0.67% (t/R= 1/75) and 2.5% (t/R= 1/20). These data point to the graphene oxide paper sample being a highly pliable macroscopic material composed of stiff (in-plane) but compliant (out-of-plane) graphene oxide layers that are tightly interlocked, allowing for high resiliency against bending.

The directed-flow assembly method described above yielded a graphene oxide paper-like sheet laminate possessing a unique layered structure where individual compliant graphene oxide sheets are interlocked/tiled together in a near-parallel fashion. Although not wishing or intending to be bound by any theory, in the initial stages of the filtration the graphene oxide sheets appear to be forced rapidly onto the surface of the Anodisc membrane by the water flow and randomly assembled (folded, crumpled, and wrinkled) on the surface of the membrane filter. After a short time the filter becomes clogged due to the deposition of the graphene oxide sheets, and the water flow slows down considerably. During the subsequent period of slow filtering (evaporation of water is also occurring), the concentration of graphene oxide sheets in the suspension appears to rise, resulting in a significant increase in the sheet-to-sheet interactions. During this stage, the sheets are more likely to be aligned on top of each other in the ever-growing deposit and are probably also “smoothed out” by the water flow. The whole filtration process takes from about 12 hours to 2 days, depending on the amount of colloidal dispersion of graphite oxide used for achieving the desired film thickness. Toward the end, one can visually observe the formation of a mat with a gradually decreasing thickness. The unique properties of the slowly flowing water in the confined galleries, together with the electrostatic and van der Waals attractive forces a between the very large aspect ratio compliant sheets of graphene oxide, appear to be largely responsible for their sequential deposition into the observed macroscopic layered structure. The top layer of the resulting graphene oxide paper is not as dense and ordered as its core. Upon drying, the van der Waals attractions between the sheets squeezed and pushed out the remaining water molecules, leaving only those that are immobilized by the formation of hydrogen bonds with donor and acceptor sites on the neighboring graphene oxide sheets.

After drying, if water is poured on top of the graphene oxide paper, the paper swells sufficiently to allow the water to seep through, and then returns back to the “dry” state. A piece of graphene oxide paper left in water for several hours does not disperse and maintains its shape (in contrast, graphite oxide powder samples disperse immediately), but disintegrates easily if it is handled while still wet. However, moderate ultrasound agitation of a wetted graphene oxide paper readily re-disperses the graphene oxide sheets into colloidal dispersions. This behavior strongly suggests that no covalent bonding was present between the individual graphene oxide sheets in the graphene oxide paper. If a wetted graphene oxide paper is left to dry, it will regain its mechanical integrity and can again be handled without failure. If a drop of water is placed on the graphene oxide surface, the water uptake is very slow and only localized seepage of water into graphene oxide paper occurs.

The large interaction surfaces between the layered graphene oxide sheets, their corrugation at the atomic scale, and their wrinkled morphology at the sub-micrometer scale, allow for a highly effective load distribution across the entire macroscopic sample, and thus make this laminate more resilient than traditional carbon- and clay-based papers. Utilization of an inexpensive starting material such as graphite oxide can facilitate the fabrication of large-area paper-like sheets for use in the preparation of membranes with controlled permeability, anisotropic ionic conductors, supercapacitors, and materials for molecular storage, among many others. Graphene oxide paper laminate also can also be infused or serve as a carrier substance for producing hybrid materials containing polymers, ceramics, and metals. Additionally, the numerous chemical functionalities on the surface of the layered graphene oxide sheets can readily lend themselves to further chemical functionalization.

Although the invention has been described in detail above with respect to certain embodiments, the invention is not limited to such embodiments since changes, modifications and omissions can be made thereot within the scope of the invention as defined in the appended claims.

1. A sheet laminate comprising individual graphene oxide sheets layered one on another in a manner to form a laminated product.

2. The laminate of claim 1 having a thickness of about 1 to 50 microns.

3. A method of making a sheet laminate comprising making a suspension of individual graphene oxide sheets and assembling the graphene oxide sheets as a sheet laminate on a fluid-permeable support by flow-directed assembly.

4. The method of claim 3 including drying the laminate on the support and releasing the dried laminate from the support.

5. The method of claim 3 wherein the suspension is subjected to continuous vacuum-assisted filtration through a membrane filter support so that the graphene oxide sheets are assembled as a laminate on the membrane filter support by directional flow through the membrane filter support.

6. The method of claim 3 wherein the suspension is made by exfoliating graphite oxide in water.
